(19) United States
(12) Patent Application Publication
(10) Pub. No.: US 2010/0197298 A1
(43) Pub. Date: Aug. 5, 2010

(54) METHOD AND APPARATUS FOR MEASUREMENT REPORT IN WIRELESS COMMUNICATION NETWORK HAVING MACRO CELLS AND FEMTO CELLS

(75) Inventors: Jung Min SO, Seoul (KR); Hee Jung BYUN, Anyang-si (KR); Mi Sun DO, Suwon-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/698,484

(22) Filed: Feb. 2, 2010

(30) Foreign Application Priority Data
Feb. 2, 2009 (KR) 10-2009-0007981

(51) Int. Cl. H04W 24/00

(52) U.S. Cl. 455/424

(57) ABSTRACT

In a wireless communication network including several macro cells each having several femto cells, when a trigger event occurs for a measurement report, user equipment creates a measurement report message which includes a cell identifier of a target femto cell for the measurement report in response to the trigger event, measuring results for the target femto cell, and a neighbor cell identifier having a cell identifier of at least one neighbor femto cell around the target femto cell. Then the user equipment transmits the measurement report message to an evolved node B (eNB). When receiving the measurement report message, the eNB distinguishes the target femto cell from others in the femto cells based on the neighbor cell identifier in the received measurement report message.

### PRIORITY

This application claims the benefit under 35 U.S.C. §119(a) of a Korean patent application filed on Feb. 2, 2009 in the Korean Intellectual Property Office and assigned Serial No. 10-2009-0007981, the entire disclosure of which is hereby incorporated by reference.

### BACKGROUND OF THE INVENTION

1. Field of the Invention

Aspects of the present invention relate to a wireless communication network having macro cells and femto cells together. More particularly, aspects of the present invention relate to a method and apparatus for a measurement report to identify femto cells in such a wireless communication network.

2. Description of the Related Art

Femto is a very small unit corresponding to one quadrillionth (10-15) of a unit. Normally a femto cell refers to a small cell that covers a very small range in a cellular system. A small cellular base station for controlling such femto cells is referred to as a femto base station or Home Node B (HNB). In some cases, a femto cell is often used to indicate a femto base station together. A pico cell is also used in a similar meaning, but a femto cell is used as having a more evolved function. A femto base station is designed as an in-house base station for use in residential or small business environments. Additionally, a femto base station is connected with a broadband router and used to relay voices and data to a backbone network of service providers.

The third Generation Partnership Project Long Term Evolution (3GPP LTE) has defined the evolved Node B (eNB) and the Home eNB (HeNB) as base stations. The eNB is a macro base station for macro cells, whereas the HeNB is a femto base station for femto cells.

Traditional ways of assigning a physical cell identity (PCID) and of differentiating cells are based on a cell environment where small base stations, such as HeNBs, are not considered. If the HeNB is limited in installation or introduced to a separate frequency allocation other than macro cells, the HeNB may also be assigned a PCID and allow user equipment to perform a cell search, as the eNB does.

This is based on the supposition that five hundred small base stations are installed per sector in a cell with an inter site distance (ISD) of 500 m. In such circumstances, if about 6000 households are clustered close together in an apartment area under the cell coverage of 400 m with 50 percent of a used rate of HeNBs, an unfavorable case where even 1000 HeNBs are required per sector may occasionally arise. In such dense environments, if PCIDs are assigned to small base stations through a co-channel in the same frequency allocation, 168 cell group IDs per sector defined in the LTE standard may inevitably cause the same PCID to be assigned three or more times. Even though dedicated channels in different frequency allocations are adopted for HeNBs, the same PCID may still be assigned two or more times. Thus, if some HeNBs in a single macro cell have the same PCID, user equipment or an eNB using a conventional cell search technique may often fail to distinguish a specific HeNB.

One way to solve the above problem is for user equipment to decode a global cell identity (GCID) contained in system information broadcasted through the most frequently repeated scheduling unit (SU-1) in a physical downlink shared channel (PDSCH), thereby inherently differentiating HeNBs with the same PCID. Such system information is transmitted once through at least eight radio frames.

In this solution, the user equipment inserts the PCID of a measuring target cell into a measurement report message and then sends the measurement report message to an eNB. If the eNB fails to determine a target cell using a received PCID, the eNB sends a request for the GCID by a long gap allocation. The user equipment then decodes the system information and reports the GCID in the system information to the eNB. Unfortunately, this method may not only invite a message overhead due to a GCID reporting procedure, but also cause a delay time of about 80ms.

### SUMMARY OF THE INVENTION

An aspect of the present invention is to address the at least above-mentioned problems and/or disadvantages and to provide at least the advantages described below. Accordingly, an aspect of the present invention is to provide a method and apparatus for a measurement report in a wireless communication network having macro cells and femto cells together while allowing a reduction in a delay time caused by distinguishing a target femto cell for a measurement report.

In accordance with an aspect of the present invention, a measurement report method of user equipment in a wireless communication network including a plurality of macro cells, each macro cell having a plurality of femto cells, is provided. The method comprises when a trigger event occurs, creating a measurement report message, the management report message including a cell identifier of a target femto cell for a measurement report in response to the trigger event, measuring results for the target femto cell, and a neighbor cell identifier having a cell identifier of at least one neighbor femto cell around the target femto cell, and transmitting the measurement report message to a base station in the wireless network.

In the measurement report method of the user equipment, the neighbor cell identifier may include a cell identifier of a specific femto cell among the neighbor femto cells neighboring the target femto cell, the specific femto cell having a signal strength greater than a given threshold.

Alternatively, the neighbor cell identifier may have the cell identifiers of the given number of specific femto cells among the neighbor femto cells neighboring the target femto cell.

In accordance with another aspect of the present invention, a measurement report method of an evolved node B (eNB) in a wireless communication network including a plurality of macro cells, each macro cell having a plurality of femto cells, is provided. The method comprises receiving a measurement report message, the measurement report message including a cell identifier of a target femto cell for a measurement report in response to a trigger event, measuring results for the target femto cell, and a neighbor cell identifier having a cell identifier of at least one neighbor femto cell around the target femto cell, and distinguishing the target femto cell from others in the plurality of femto cells based on the neighbor cell identifier in the received measurement report message.

In the measurement report method of the eNB, the distinguishing of the target femto cell may include: comparing the neighbor cell identifier in the measurement report message with a neighbor cell identifier of each femto cell stored in advance in the eNB; and determining a particular femto cell as the target femto cell among the femto cells stored in the eNB, the particular femto cell having at least the given number of the neighbor cell identifiers which are identical with the neighbor cell identifiers in the measurement report message.

In accordance with still another aspect of the present invention, a measurement report apparatus of user equipment in a wireless communication network including a plurality of macro cells, each macro cell having a plurality of femto cells, is provided. The apparatus comprises a measurement report generation unit unit configured to create a measurement report message when a trigger event occurs, the measurement report message including a cell identifier of a target femto cell for a measurement report in response to the trigger event, measuring results for the target femto cell, and a neighbor cell identifier having a cell identifier of at least one neighbor femto cell around the target femto cell, and a transmission unit configured to transmit the measurement report message to a base station in the wireless communication network.

In the measurement report apparatus of the user equipment, the neighbor cell identifier may include the cell identifier of a specific femto cell among the neighbor femto cells neighboring the target femto cell, the specific femto cell having signal strength greater than a given threshold.

Alternatively, the neighbor cell identifier may include the cell identifiers of the given number of specific femto cells among the neighbor femto cells neighboring the target femto cell.

In accordance with yet another aspect of the present invention, a measurement report apparatus of an evolved node B (eNB) in a wireless communication network including a plurality of macro cells, each macro cell having a plurality of femto cells, is provided. The apparatus comprises a receiving unit configured to receive a measurement report message which includes a cell identifier of a target femto cell for a measurement report in response to a trigger event, measuring results for the target femto cell, and a neighbor cell identifier having a cell identifier of at least one neighbor femto cell around the target femto cell, and an identification unit configured to distinguish the target femto cell from others in the plurality of femto cells based on the neighbor cell identifier in the measurement report message received by the receiving unit.

In the measurement report apparatus of the eNB, the identification unit may be further configured to compare the neighbor cell identifier in the measurement report message with a neighbor cell identifier of each femto cell stored in advance in the eNB, and to determine a particular femto cell as the target femto cell among the femto cells stored in the eNB, the particular femto cell having at least the given number of the neighbor cell identifiers identical with the neighbor cell identifiers in the measurement report message.

Aspects of the present invention may allow the macro base station (eNB) to eliminate a procedure of ascertaining GCID for exact cell identification when the eNB receives a measurement report message from user equipment, thus favorably reducing a message overhead and a delay time due to a GCID reporting procedure. Therefore, this may improve the quality of a wireless communication service and related system performance.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIGS. 1A and 1B are schematic views which illustrate a configuration of a wireless communication network having macro cells and femto cells together according to an exemplary embodiment of the present invention;

FIG. 2 is a schematic view which illustrates a measurement report method according to an exemplary embodiment of the present invention;

FIG. 3 is a flow diagram which illustrates a measurement report method for distinguishing a home evolved node B (HeNB) according to an exemplary embodiment of the present invention;

FIG. 4 is a flow diagram which illustrates a measurement report method of user equipment according to an exemplary embodiment of the present invention; and

FIG. 5 is a flow diagram which illustrates a method for distinguishing a femto cell by an evolved node B (eNB) according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope of the invention. Also, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

A structure of a wireless communication network according to an embodiment of the present invention will now be described. In embodiments of this invention, a wireless communication network is based on a cellular system and has macro cells and femto cells together.

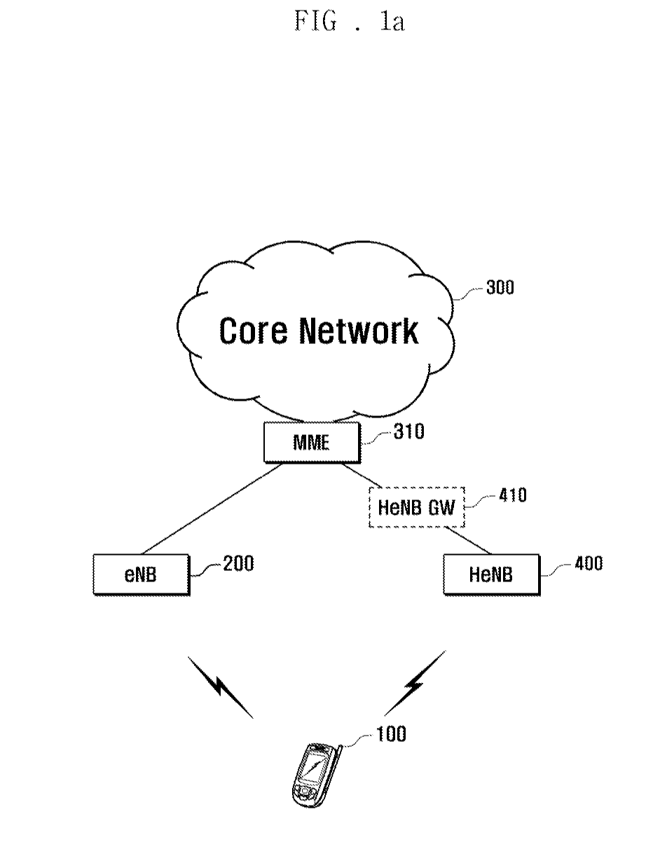

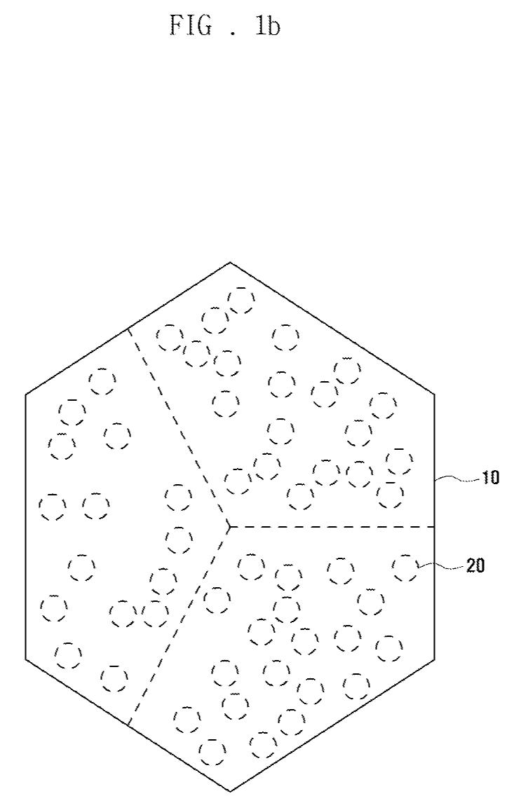

FIGS. 1A and 1B are schematic views which illustrate a configuration of a wireless communication network having macro cells and femto cells together according to an exemplary embodiment of the present invention.

Referring to FIG. 1A, the wireless communication network includes a core network 300 having a mobility management entity (MME) 310, at least one macro base station 200 (hereinafter, referred to as evolved Node B (eNB)) connected with the core network 300, at least one femto base station 400 (hereinafter, referred to as Home eNB (HeNB)) connected with the core network 300 through a gateway 410 (also referred to as HeNB GW), and at least one user equipment (UE) 100 allowing access to the eNB 200 and the HeNB 400. FIG. 1B shows a macro cell 10 controlled by the eNB 200, and a plurality of femto cells 20 belonging to the coverage of the macro cell 10. The macro cell 10 refers to a cell in a normal cellular system.

Each individual femto cell 20 is controlled by the HeNB 400 and has a size much smaller than the macro cell 10. The femto cell 20 supports a small-scale environment, such as a house or a room. As illustrated, many femto cells 20 may exist in a single macro cell 10.

The user equipment 100 acquires a physical cell identity (PCID), also referred to as L1 cell ID, from the eNB 200 or the HeNB 400. The user equipment 100 may then perform a search for a sync channel (SCH) or a measurement for channel conditions with the base stations 200 and 400. A total of five hundred four (504) PCIDs are defined, and operators may dedicate some particular PCIDs for the femto cells 20. However, the present invention is not limited by the number of defined PCIDs, and more or less PCIDs may be assigned.

The user equipment 100 may access the core network 300 through the eNB 200 or the HeNB 400. Hereinafter, the core network 300 will be regarded as including the MME 310. Therefore, parts or all of functions performed by the core network 300 may be performed by the MME 310. The other well known configurations of the core network 300 will be not shown or described.

Strictly speaking, the macro cell 10 indicates a service area of a single eNB 200, and the femto cell 20 indicates a service area of a single HeNB 400. However, in embodiments of this invention, “a base station” and “a cell” will be often used interchangeably. For example, a “femto cell” may be used to refer to the HeNB 400 managing the femto cell. Thus the term “cell” should be understood as also referring to the base station (for example, the HeNB 400) managing the cell.

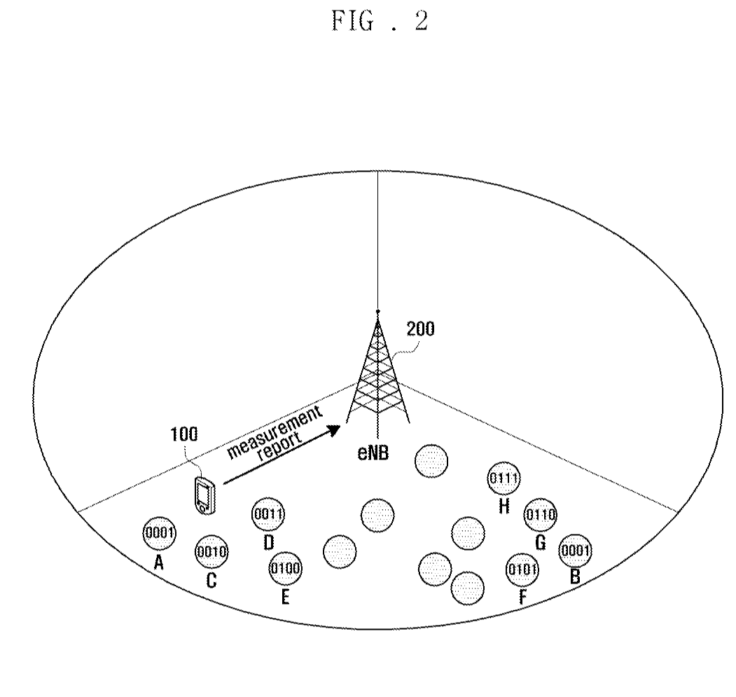

As discussed above, the wireless communication network is supposed to be based on a cellular system in which the macro cells and the femto cells exist together. A measurement report method in such a cellular system according to an embodiment of this invention is described with reference to FIG. 2. FIG. 2 is a schematic view which illustrates a measurement report method according to an exemplary embodiment of the present invention.

Referring to FIG. 2, a plurality of femto cells exist in a certain sector of the eNB 200. Suppose that two femto cells A and B use a cell identifier “0001”. Also, suppose that three femto cells C, D, and E located around the femto cell A have cell identifiers “0010, 0011, and 0100”, respectively. Similarly, suppose that three femto cells F, G, and H located around the femto cell B have cell identifiers “0101, 0110, and 0111”, respectively. The cell identifiers may be, for example, a PCID.

According to an exemplary embodiment of the present invention, when sending a measurement report, the user equipment 100 inserts the cell identifiers of neighbor femto cells, located around a target femto cell for measurement, into that report. Therefore, the eNB 200 can know which of several femto cells having the same cell identifier is being referred to in the measurement report.

The eNB 200 can thus identify a target femto cell for a measurement report via the cell identifiers of neighbor femto cells without using a GCID. In the meantime, the user equipment 100 performs signal measurement for several cells as well as a target cell. Herein, the neighbor femto cells refer to specific femto cells having a signal strength greater than a given threshold, among the cells around (i.e., neighboring) the target femto cell.

For a measurement report, the user equipment 100 sends a measurement report message regarding a specific cell A to a serving base station, namely, the eNB 200. At this time, the user equipment 100 performs a mapping between the cell identifier “0001” of the cell A and a measuring result of channel conditions. Since both cells A and B use the same cell identifier “0001”, the eNB 200 may not know whether a received measurement report is regarding the cell A or the cell B.

However, according to an exemplary embodiment of the present invention, when sending a measurement report message regarding a specific femto cell, the user equipment 100 also reports the cell identifiers of a certain number (k) of neighbor femto cells having signal strength greater than a given threshold among the measured neighbor femto cells.

For instance, suppose that the cell identifiers of three neighbor femto cells are to be inserted into a measurement report message. In such a case, when sending a measurement report message regarding the cell A to the eNB 200, the user equipment 100 inserts the cell identifiers “0010, 0011, and 0100” of three neighbor femto cells near the cell A.

The eNB 200 which receives the above measurement report message from the user equipment 100 can therefore know the cell A to be a target cell for a measurement report since the cell A is nearer to “0010, 0011 and 0100” than the cell B. The eNB 200 can therefore distinguish a specific target cell without requiring a GCID.

In an uncommon case, if there are femto cells with the cell identifiers “0010, 0011 and 0100” around both cells A and B, the eNB may fail to determine the cell despite using the cell identifiers of neighbor femto cells. In such uncommon cases, the eNB may receive GCID from the user equipment 100 through a GCID reporting procedure.

As discussed hereinbefore, an exemplary embodiment of the present invention may allow the eNB 200 to eliminate a procedure of ascertaining GCID by allocating a long gap whenever the user equipment 100 sends a measurement report message regarding the HeNB 400. The performance of a system can thus be enhanced. In addition, the above-discussed measurement report method according to an exemplary embodiment of the present invention may assign the same cell identifier to some femto cells located apart at a given distance among all femto cells within the coverage of the eNB 200, thus improving efficiency.

Methods for assigning a cell identifier to a specific HeNB 400 according to exemplary embodiments of the present invention shall now be described. These methods may include a method based on the location of the HeNB 400, a method using a UE mode of the HeNB 400, and a method using the user equipment 100.

First, a cell identifier assignment method using the location of the HeNB 400 is as follows. When a new HeNB 400 is installed and registered in the core network 300, the operator can know an address of a location where that HeNB 400 is installed. This permits estimating location information. The core network 300 which comes to know the location of a new HeNB 400 estimates the macro cell containing the newly installed HeNB 400 and also estimates the locations of neighbor HeNBs 400 around the newly installed HeNB 400.

Then the core network 300 assigns a suitable cell identifier to the newly installed HeNB 400, provided that the cell identifier is not the same as existing cell identifiers of the neighbor HeNBs 400. According to this method, the core network 300 should estimate the location of the newly installed HeNB 400. Such estimation of the location may employ a global positioning system (GPS) when the HeNB 400 has a GPS module therein. Alternatively, the location may be estimated through an address of a subscriber registered in the HeNB 400. The core network may also employ other techniques to estimate the location of the HeNB 400.

Second, a cell identifier assignment method using a UE mode (i.e., over-the-air function) of the HeNB 400 is as follows. In this case, the HeNB 400 operates in the UE mode where the HeNB 400 does not perform duties of a base station, but operates like the user equipment 100. In the UE mode, a newly installed HeNB 400 searches neighbor HeNBs 400 and then selects a cell identifier which is not used by the neighbor HeNBs 400.

Third, a cell identifier assignment method using the user equipment 100 is as follows. This method, also referred to as a UE-assisted automatic neighbor relation (ANR) method, allows the user equipment 100 to search neighbor HeNBs 400. For this purpose, the HeNB 400 should enter into an operation mode to perform duties of a base station.

In order to initiate a wireless communication with the user equipment 100, a newly installed HeNB 400 establishes a temporary cell identifier. In some embodiments, a specified part of 504 cell identifiers may be allotted in advance for temporary cell identifiers.

After entering into the operation mode, the newly installed HeNB 400 receives respective measurement report messages from some user equipment 100 and thereby ascertains the cell identifiers of neighbor HeNBs 400. After a given time elapses, the newly installed HeNB 400 selects a cell identifier which is not used by the neighbor HeNBs 400, relying on the received measurement report messages to make the selection.

The above-discussed methods for assigning a cell identifier to the HeNB 400 may allow well distributed assignment of cell identifiers so that the same cell identifier is not assigned to two femto cells located within a given distance from each other (i.e., spaced insufficiently) in a single macro cell.

Under conditions where cell identifiers are properly assigned to the respective femto cells via one of the above methods, the eNB 200 stores in advance a neighbor cell list which records the cell identifiers of neighbor cells around a specific femto cell. Depending on such a neighbor cell list, the eNB 200 determines whether to have to perform a GCID reporting procedure or to be able to identify a cell using cell identifiers only.

The following Table 1 shows an example of a neighbor cell list stored in the eNB 200.

TABLE 1

| | Cell Identifier | | | Neighbor Cell |
|---|---|---|---|---|
| | (PCID) | GCID | . . . | Identifier |
| Cell A | 0001 | A | . . . | 0010, 0011, 0100 |
| Cell B | 0001 | B | . . . | 0101, 0110, 0111 |
| | . . . | . . . | . . . | . . . |

Referring to Table 1, a neighbor cell list records the HeNBs 400 which belong to the macro cell coverage of the eNB 200. The neighbor cell list contains information used to distinguish or identify each individual HeNB 400. As shown in Table 1, information recorded in a neighbor cell list may include the cell identifier (e.g., PCID) and GCID of each HeNB 400, and neighbor cell identifiers. The neighbor cell identifiers refer to the cell identifiers of neighbor cells around each HeNB 400, etc. For instance, the neighbor cell identifiers regarding a cell A are “0010”, “0011”, and “0100”, whereas the neighbor cell identifiers regarding a cell B are “0101”, “0110”, and “0111”.

Referring to Table 1 and FIG. 2, there is a case where two cells have the same cell identifier “0001”. In an exemplary embodiment of the present invention, such cells with a duplicate cell identifier may be distinguished from each other via their different neighbor cell identifiers (such as PCIDs). Of course, such cells with a duplicate cell identifier may be alternatively distinguished through their GCIDs. However, as discussed above, since a procedure of receiving a measurement report message including GCIDs may unfavorably cause a delay time, a method using GCIDs should be limited to uncommon cases where it is impossible to distinguish cells even by using neighbor cell identifiers.

In the first method for cell identifier assignment discussed above, the core network 300 uses location information about all HeNBs 400 to assign a suitable cell identifier (other than a cell identifier of a neighbor HeNB) to the newly installed HeNB 400. In this fashion, the neighbor cell identifiers may be initially established when a neighbor cell list is created.

Whenever the user equipment 100 transmits a measurement report message, the neighbor cell identifiers regarding a specific cell transmitted may be updated. For instance, if any neighbor cell identifier is not reported for a given time through a measurement report message, the neighbor cell identifier may be completely removed from the neighbor cell list.

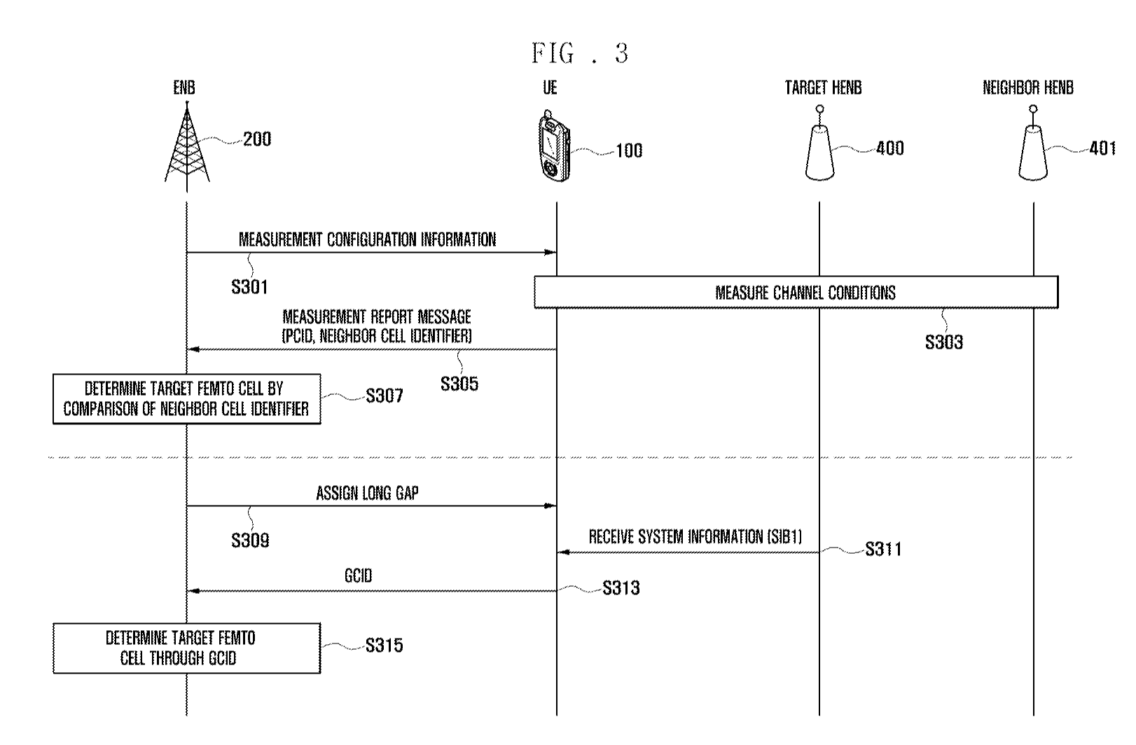

A measurement report method for distinguishing HeNBs is described hereinafter. FIG. 3 is a flow diagram of a measurement report method for distinguishing a home evolved node B (HeNB) in accordance with an exemplary embodiment of the present invention. In FIG. 3, it is supposed that the eNB 200 stores a neighbor cell list as discussed above.

Referring to FIGS. 2 and 3, at the outset, the eNB 200 sends measurement configuration information to the user equipment 100 in step 5301. Such configuration information may include the maximum number (k) of neighbor femto cells to be reported from the user equipment 100 to the eNB 200, and the signal strength threshold of neighbor femto cells to be included in the neighbor cell identifiers of a neighbor cell list.

The maximum number (k) of neighbor femto cells to be reported is a parameter which indicates the maximum number of cell identifiers included in neighbor cell identifiers to be sent together during a measurement report regarding a specific cell. Therefore the eNB 200 can regulate the number of cell identifiers of the HeNBs 400 included in neighbor cell identifiers.

The signal strength threshold is a parameter which allows the user equipment to report only femto cells with signal strength greater than a given threshold. The signal strength threshold is the minimum signal strength of neighbor cells to be included in neighbor cell identifiers. If necessary, the signal strength threshold may be omitted. In such a case, all neighbor cell identifiers regarding a specific cell measured may be included in a neighbor cell list, regardless of their signal strength.

The aforesaid parameters may be varied by the eNB 200 according to the density of femto cells in the macro cell coverage. Alternatively, the core network 300 may determine such parameters and then instruct the eNB 200 accordingly.

Suppose that the user equipment 100 receiving and storing configuration information from the eNB 200 is approaching the cell A as shown in FIG. 2. Furthermore, suppose that a trigger event occurs according to a signal of the HeNB 400 controlling the cell A.

Thus, circumstances where the signal strength of the cell A increases as much as a trigger event may occur at the approach of user equipment 100. Such a trigger event may occur when a signal of the cell A is higher than a threshold or higher than a predefined offset plus a signal of the eNB 200. The occurrence of a trigger event may depend on other conditions as well. If a trigger event occurs, the user equipment 100 measures the channel conditions of neighbor HeNBs 401 as well as a target HeNB 400 in step S303.

Then the user equipment 100 sends a measurement report message including measuring results to the eNB 200 in step S305. At this time, a measurement report message includes the cell identifier of the target HeNB 400, measuring results for the target HeNB 400, and neighbor cell identifiers which record the respective cell identifiers of the neighbor HeNBs 401. Here, limitations in number and signal strength of the neighbor HeNBs 401 included in neighbor cell identifiers may comply with configuration information that the user equipment 100 received earlier.

The following Table 2 shows an example of a measurement report message.

TABLE 2

| Cell Identifier of | Measuring | Neighbor Cell |
|---|---|---|
| Target HeNB | Result | Identifier |
| 0001 | . . . | 0010, 0011, 0100 |

As shown in Table 2, the user equipment 100 inserts the cell identifier of the target HeNB 400, measuring results, and neighbor cell identifiers regarding the target HeNB 400 into a measurement report message. The neighbor cell identifiers include the cell identifiers of the respective neighbor HeNBs 401. The neighbor cell identifiers comply with configuration information received in advance. The number and signal strength of the neighbor HeNBs 401 included in the neighbor cell identifiers may comply with configuration information received earlier from the eNB 200.

For instance, suppose that femto cells C, D, and E have signal strength greater than a threshold defined in the configuration information. In such a case, although a trigger event does not occur in any femto cells C, D, and E, the user equipment 100 inserts neighbor cell identifiers having PCIDs 0010, 0011, and 0100 of femto cells C, D, and E into a measurement report message and then sends the measurement report.

Through the neighbor cell identifiers, the eNB 200 can ascertain that the target HeNB 400 for a measurement report received from the user equipment 100 is the cell A, without requiring a GCID reporting. The eNB 200 determines a target femto cell for a measurement report by comparing neighbor cell identifiers between the received measurement report message and the stored neighbor cell list in step S307.

Specifically, referring to Tables 1 and 2, the eNB 200 finds at least one specific cell, and frequently two or more specific cells, in the stored neighbor cell list. Each of these specific cells has the same cell identifier as included in the received measurement report message. In this case, the eNB 200 compares neighbor cell identifiers included in the measurement report message with those of each found cell in the neighbor cell list, and selects a single particular cell among the found cells. The selected particular cell may have at least N neighbor cell identifiers identical with those included in the measurement report message. The value N may be determined by the eNB 200 or the core network 300 based on the density of femto cells in the cell coverage of the eNB 200.

For instance, in circumstances as shown in FIG. 2, suppose that a neighbor cell list and a measurement report message are the above Tables 1 and 2, respectively. Also, suppose that the value of N is two. Then the eNB 200 can find, in the neighbor cell list, two cells A and B which have the same cell identifier as the cell identifier “0001” of a target HeNB in the measurement report message. In this case, though knowing the cell identifier of the target HeNB, the eNB 200 cannot determine a target cell for a measurement report. Therefore, the eNB 200 ascertains that the received measurement report message has neighbor cell identifiers “0010, 0011, and 0100”, and then selects the cell A between the found cells A and B since the cell A has the same neighbor cell identifiers of at least two as those in the measurement report message. The eNB 200 can therefore determine that the received measurement report message is related to the cell A.

In an uncommon case, although receiving the aforesaid measurement report message having neighbor cell identifiers, the eNB may fail to determine a target cell for a measurement report. One example is a case where all cells in the neighbor cell list have less than N identical neighbor cell identifiers, and another is a case where two or more cells have respectively at least N identical neighbor cell identifiers. In such cases, the eNB 200 assigns a long gap for requesting GCID to the user equipment 100 in step S309. Then the user equipment 100 receives system information (SIB1) from the target HeNB 400 in step S311, and reports the GCID of the received system information to the eNB 200 in step S313. Therefore, in these uncommon cases, the eNB 200 can determine a target cell for a measurement report via the reported GCID in step S315.

The user equipment 100 and the eNB 200, each of which performs a measurement report, are described hereinafter.

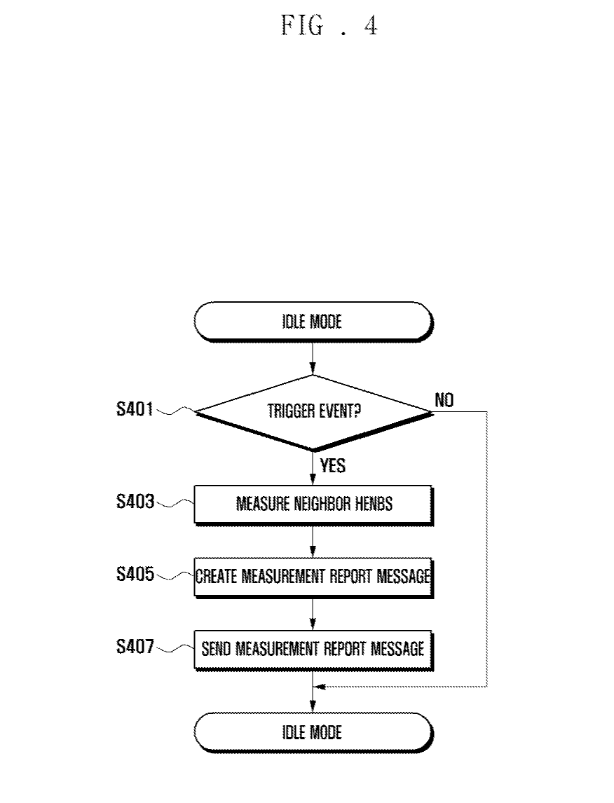

FIG. 4 is a flow diagram which illustrates a measurement report method of user equipment according to an exemplary embodiment of the present invention. Referring to FIG. 4, it is supposed that the user equipment 100 receives and stores configuration information from the eNB 200 in advance. Additionally, the user equipment 100 is approaching a specific HeNB 400 within the cell coverage of the eNB 200, thereby causing a trigger event.

Then the user equipment 100 detects the occurrence of a trigger event in step S401, and performs measurement regarding neighbor HeNBs 401 as well as the approaching target HeNB 400 in step S403. The definition of the neighbor HeNBs 401 complies with the earlier stored configuration information.

Thereafter, the user equipment 100 creates a measurement report message in step S405. As discussed above in Table 2, such a measurement report message includes the cell identifier of the target HeNB 400, measuring results, and neighbor cell identifiers.

Next, the user equipment 100 sends the measurement report message to the eNB 200 in step S407. As fully discussed above, the eNB 200 receiving the measurement report message may determine the target HeNB 400, depending on neighbor cell identifiers in the measurement report message. For instance, the eNB 200 compares neighbor cell identifiers included in the measurement report message with those of each cell recorded in the neighbor cell list, and then selects a single particular HeNB with at least N identical neighbor cell identifiers in the neighbor cell list.

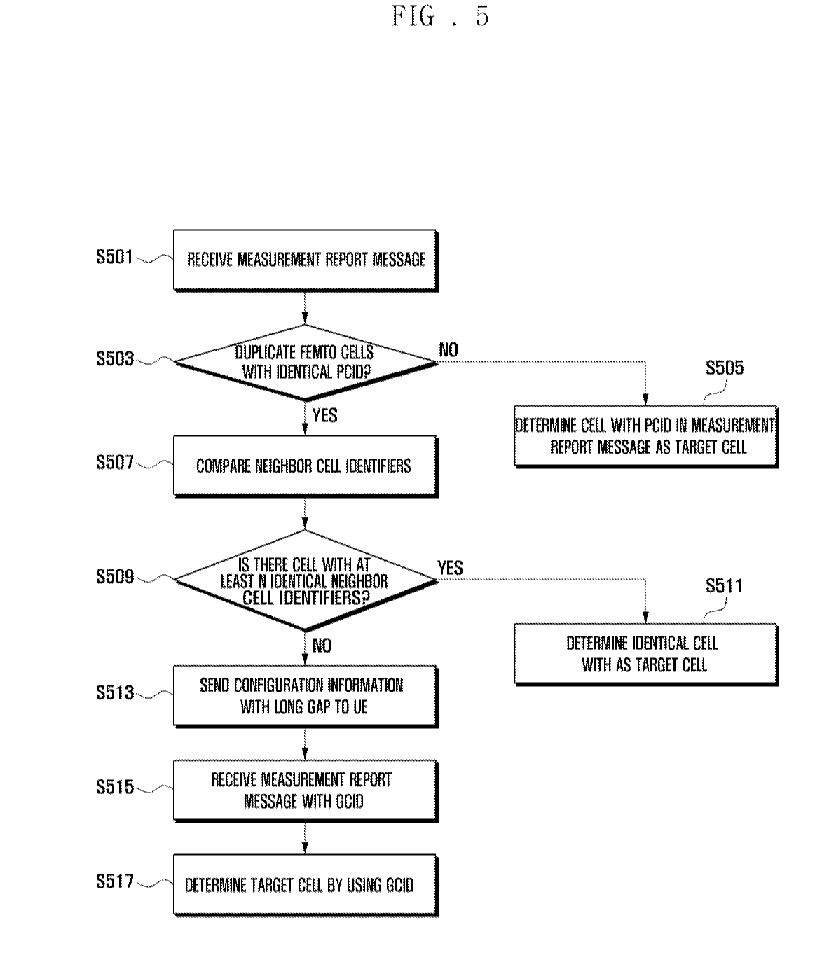

A method by which the eNB 200 distinguishes a femto cell in connection with the aforesaid measurement report method is described hereinafter. FIG. 5 is a flow diagram of a method for distinguishing a femto cell by an evolved node B (eNB) according to an exemplary embodiment of the present invention.

Referring to FIG. 5, the eNB 200 stores in advance a neighbor cell list which records HeNBs located within its own coverage. In the meantime, as discussed previously in FIG. 4, the user equipment 100 measures neighboring HeNBs including a target HeNB when a trigger event occurs, and sends a measurement report message having measuring results to the eNB 200. As discussed previously in Table 2, it is supposed that the measurement report message contains the cell identifier “0001” of the target cell, measuring results, and neighbor cell identifiers “0010, 0011, and 0100”.

Then the eNB 200 receives the measurement report message from the user equipment 100 in step S501. Next, the eNB 200 determines whether the neighbor cell list includes duplicate femto cells each of which has an identical cell identifier with the target femto cell in the received measurement report message in step S503.

If there are no duplicate femto cells, the eNB 200 determines in the neighbor cell list that a specific femto cell having the same cell identifier as in the measurement report message is a target cell for a measurement report in step S505. If there are duplicate femto cells, the eNB 200 compares neighbor cell identifiers in the measurement report message with those of each found cell in the neighbor cell list in step S507.

As the result of the comparison, the eNB 200 determines whether there is a particular femto cell having at least N identical neighbor cell identifiers in the neighbor cell list in step S509. If there is such a cell, the eNB 200 determines that the particular cell with at least N identical neighbor cell identifiers is a target cell for a measurement report in step S511.

For instance, the neighbor cell list of the eNB 200 may have two cells with the same cell identifier “0001”. That is, as discussed earlier in Table 1, the neighbor cell list may have two cells A and B, namely, the first cell A having the cell identifier (PCID) “0001”, the GCID “A”, and the neighbor cell identifiers “0010, 0011 and 0100”, and the second cell B having the cell identifier (PCID) “0001”, the GCID “B”, and the neighbor cell identifiers “0101, 0110 and 0111”.

In such a case, if N is two, at least two neighbor cell identifiers of the first cell A are identical with those of the measurement report message. Therefore, the eNB 200 determines that the first cell A is a target cell for a measurement report in step S511.

On the other hand, if there is no cell as the result of comparison in step S509, the eNB 200 sends measurement configuration information including the assignment of a long gap to the user equipment 100 in step S513. When receiving configuration information including the assignment of a long gap, the user equipment 100 receives GCID transmitted once through eight frames and sends a measurement report message including the received GCID to the eNB 200. Then the eNB 200 receives the measurement report message including the GCID in step S515 and determines a target cell in the neighbor cell list based on the GCID and cell identifiers in step S517.

Now, and an exemplary configuration of a device and a base station will be described respectively. The device denotes the user equipment 100 and the base station denotes eNB 200 or HeNB 400.

First, a configuration of the device is described hereinafter. The device includes a measurement report generation unit and a transmission unit.

The measurement report generation unit creates a measurement report message when a trigger event occurs, the measurement report message including a cell identifier of a target femto cell for a measurement report in response to the trigger event, measuring results for the target femto cell, and a neighbor cell identifier having a cell identifier of at least one neighbor femto cell around the target femto cell.

The transmission unit for transmitting the measurement report message to a base station in the wireless communication network. The neighbor cell identifier includes the cell identifier of a specific femto cell among the neighbor femto cells around the target femto cell, the specific femto cell having a signal strength greater than a given threshold. The neighbor cell identifier includes the cell identifiers of the given number of specific femto cells among the neighbor femto cells around the target femto cell.

Next, a configuration of the base station is described hereinafter. The base station includes a receiving unit and an identification unit.

The receiving unit for receiving a measurement report message including a cell identifier of a target femto cell for a measurement report in response to a trigger event, measuring results for the target femto cell, and a neighbor cell identifier having a cell identifier of at least one neighbor femto cell neighboring the target femto cell; and

The identification unit for distinguishing the target femto cell from others in the plurality of femto cells based on the neighbor cell identifier in the measurement report message received by the receiving unit. The identification unit is further configured to compare the neighbor cell identifier in the measurement report message with a neighbor cell identifier of each femto cell stored in advance in the eNB, and to determine a particular femto cell as the target femto cell among the femto cells stored in the eNB, the particular femto cell having at least the given number of the neighbor cell identifiers identical with the neighbor cell identifiers in the measurement report message.

Now, and another exemplary configuration of a device and a base station will be described respectively. The device denotes the user equipment 100 and the base station denotes eNB 200 or HeNB 400.

First, a configuration of the device is described hereinafter. The device includes a measurement report unit and a communication unit.

The measurement report unit generates a measurement report message when a trigger event occurs. The measurement report message includes a cell identifier of a target femto cell, measuring results for the target femto cell, and a neighbor cell identifier having a plurality of cell identifiers, each cell identifier corresponding to a femto cell neighboring the target femto cell.

The communication unit for transmitting the measurement report message to a base station in the wireless communication network.

When the communication unit receives a message from the base station indicating that the target femto cell cannot be identified based on the neighbor cell identifier, the measurement report unit requests system information including a specific identifier of the target femto cell, and the communication unit transmits the received specific identifier to the base station.

Next, a configuration of the base station is described hereinafter. The base station includes a communication unit, a measurement report unit and a storage unit.

The communication unit for communicates with user equipment in the wireless communication network.

The measurement report unit for receiving a measurement report from the user equipment corresponding to a target femto cell and to identify the target femto cell based on a neighbor cell identifier in the measurement report, the neighbor cell identifier including a plurality of cell identifiers, each cell identifier in the neighbor cell identifier identifying a femto cell neighboring the target femto cell.

The storage unit for storing a neighbor cell list, the neighbor cell list having a plurality of entries, each entry corresponding to a femto cell and including a cell identifier for the corresponding femto cell, a specific identifier for the corresponding femto cell, and a neighbor cell identifier for the corresponding femto cell, wherein the neighbor cell list has at least two entries with the same cell identifier.

The measurement report unit compares the neighbor cell identifier in the measurement report with the neighbor cell identifier in each of the entries, and identifies the target femto cell as a femto cell corresponding an entry if exactly one entry has a neighbor cell identifier with at least a given number of cell identifiers that are the same as the cell identifiers in the measurement report.

when the measurement report unit determines that the neighbor cell list does not include exactly one entry in which the neighbor cell identifier has at least a given number of cell identifiers that are the same as the cell identifiers in the measurement report, the measurement report unit obtains a specific identifier of the target femto cell from the user equipment via the communication unit, and identifies the target femto cell corresponding to an entry in the neighbor cell list having the same specific identifier as the specific identifier received from the user equipment.

After the measurement report unit identifies the target femto cell, the measurement report unit updates the neighbor cell identifier in the entry in the neighbor cell list corresponding to the target femto cell with the neighbor cell identifier in the received measurement report.

As fully discussed hereinbefore, according to exemplary embodiments of the present invention, the eNB 200 can eliminate a procedure of ascertaining GCID for exact cell identification when receiving a measurement report message from the user equipment 100, thus favorably reducing a message overhead and a delay time due to a GCID reporting procedure. Therefore, this may improve the quality of a wireless communication service and related system performance.

While the invention has been shown and described with reference certain exemplary embodiments thereof, it will be understood by those skilled in the art that various changes in form and details may be made therein without departing from the spirit and scope of the invention as defined by the appended claims and their equivalents.

What is claimed is:

1. A measurement report method of user equipment in a wireless communication network including macro cells, each macro cell having a plurality of femto cells, the method comprising:
when a trigger event occurs, creating a measurement report message, the measurement report message including a cell identifier of a target femto cell for a measurement report in response to the trigger event, measuring results for the target femto cell, and a neighbor cell identifier having a cell identifier of at least one neighbor femto cell around the target femto cell; and
transmitting the measurement report message to a base station in the wireless communication network.

2. The method of claim 1, wherein the neighbor cell identifier includes a cell identifier of a specific femto cell among the neighbor femto cells neighboring the target femto cell, the specific femto cell having a signal strength greater than a given threshold.

3. The method of claim 1, wherein the neighbor cell identifier includes the cell identifiers of the given number of specific femto cells among the neighbor femto cells neighboring the target femto cell.

4. A measurement report method of an evolved node B (eNB) in a wireless communication network which includes macro cells each of which has a plurality of femto cells, the method comprising:
receiving a measurement report message, the measurement report message including a cell identifier of a target femto cell for a measurement report in response to a trigger event, measuring results for the target femto cell, and a neighbor cell identifier having a cell identifier of at least one neighbor femto cell around the target femto cell; and
distinguishing the target femto cell from others in the plurality of femto cells based on the neighbor cell identifier in the received measurement report message.

5. The method of claim 4, wherein the distinguishing of the target femto cell includes:
comparing the neighbor cell identifier in the measurement report message with a neighbor cell identifier of each femto cell stored in advance in the eNB; and
determining a particular femto cell as the target femto cell among the femto cells stored in the eNB, the particular femto cell having at least the given number of the neighbor cell identifiers which are identical with the neighbor cell identifiers in the measurement report message.

6. A measurement report apparatus of user equipment in a wireless communication network including a plurality of macro cells, each macro cell having a plurality of femto cells, the apparatus comprising:
a measurement report generation unit for creating a measurement report message when a trigger event occurs, the measurement report message including a cell identifier of a target femto cell for a measurement report in response to the trigger event, measuring results for the target femto cell, and a neighbor cell identifier having a cell identifier of at least one neighbor femto cell around the target femto cell; and
a transmission unit for transmitting the measurement report message to a base station in the wireless communication network.

7. The apparatus of claim 6, wherein the neighbor cell identifier includes the cell identifier of a specific femto cell among the neighbor femto cells around the target femto cell, the specific femto cell having a signal strength greater than a given threshold.

8. The apparatus of claim 6, wherein the neighbor cell identifier includes the cell identifiers of the given number of specific femto cells among the neighbor femto cells around the target femto cell.

9. A measurement report apparatus of an evolved node B (eNB) in a wireless data network which includes macro cells, each macro cell having a plurality of femto cells, the apparatus comprising:
a receiving unit for receiving a measurement report message including a cell identifier of a target femto cell for a measurement report in response to a trigger event, measuring results for the target femto cell, and a neighbor cell identifier having a cell identifier of at least one neighbor femto cell neighboring the target femto cell; and
an identification unit for distinguishing the target femto cell from others in the plurality of femto cells based on the neighbor cell identifier in the measurement report message received by the receiving unit.

10. The apparatus of claim 9, wherein the identification unit is further configured to compare the neighbor cell identifier in the measurement report message with a neighbor cell identifier of each femto cell stored in advance in the eNB, and to determine a particular femto cell as the target femto cell among the femto cells stored in the eNB, the particular femto cell having at least the given number of the neighbor cell identifiers identical with the neighbor cell identifiers in the measurement report message.

11. A device to communicate in a wireless communication network having a plurality of macro cells, each macro cell including a plurality of femto cells, the device comprising:
a measurement report unit for generating a measurement report message when a trigger event occurs, the measurement report message including a cell identifier of a target femto cell, measuring results for the target femto cell, and a neighbor cell identifier having a plurality of cell identifiers, each cell identifier corresponding to a femto cell neighboring the target femto cell; and
a communication unit for transmitting the measurement report message to a base station in the wireless communication network.

12. The device of claim 11, wherein, when the communication unit receives a message from the base station indicating that the target femto cell cannot be identified based on the neighbor cell identifier, the measurement report unit requests system information including a specific identifier of the target femto cell, and the communication unit transmits the received specific identifier to the base station.

13. A base station in a wireless communication network having a plurality of macro cells, each macro cell having a plurality of femto cells, the base station comprising:
a communication unit for communicating with user equipment in the wireless communication network;
a measurement report unit for receiving a measurement report from the user equipment corresponding to a target femto cell and to identify the target femto cell based on a neighbor cell identifier in the measurement report, the neighbor cell identifier including a plurality of cell identifiers, each cell identifier in the neighbor cell identifier identifying a femto cell neighboring the target femto cell.

14. The base station of claim 13, further comprising:
a storage unit for storing a neighbor cell list, the neighbor cell list having a plurality of entries, each entry corresponding to a femto cell and including a cell identifier for the corresponding femto cell, a specific identifier for the corresponding femto cell, and a neighbor cell identifier for the corresponding femto cell;
wherein the neighbor cell list has at least two entries with the same cell identifier; and
the measurement report unit compares the neighbor cell identifier in the measurement report with the neighbor cell identifier in each of the entries, and identifies the target femto cell as a femto cell corresponding an entry if exactly one entry has a neighbor cell identifier with at least a given number of cell identifiers that are the same as the cell identifiers in the measurement report.

15. The base station of claim 14, wherein, when the measurement report unit determines that the neighbor cell list does not include exactly one entry in which the neighbor cell cell identifier has at least a given number of cell identifiers that are the same as the cell identifiers in the measurement report, the measurement report unit obtains a specific identifier of the target femto cell from the user equipment via the communication unit, and identifies the target femto cell corresponding to an entry in the neighbor cell list having the same specific identifier as the specific identifier received from the user equipment.

16. The base station of claim 14, wherein, after the measurement report unit identifies the target femto cell, the measurement report unit updates the neighbor cell identifier in the entry in the neighbor cell list corresponding to the target femto cell with the neighbor cell identifier in the received measurement report.

17. The base station of claim 14, wherein the base station is an evolved node B (eNB) base station.

18. The base station of claim 14, wherein the base station is a home eNB base station.
